(19) United States
(12) Patent Application Publication
(10) Pub. No.: US 2015/0164716 A1
(43) Pub. Date: Jun. 18, 2015

(54) Reconfigurable Passenger Restraint

(71) Applicant: Alexander Dennis Limited, Camelon Falkirk (GB)

(72) Inventors: Eammon Kilduff, Larbert (GB); Chris Cox, Larbert (GB)

(21) Appl. No.: 14/564,647

(22) Filed: Dec. 9, 2014

(30) Foreign Application Priority Data
Dec. 9, 2013 (GB) 1321761.7

(51) Int. Cl. A61G 3/08; B60R 22/22

(52) U.S. Cl. CPC A61G 3/0808; B60R 22/22

(57) ABSTRACT

A wheelchair restraint for a passenger service vehicle with at least a portion of the restraint reconfigurable between a first position and a second position. The first position is a storage or access position. The second position is an operational or restraining position. The at least a portion of the restraint includes a substantially rigid restraining member.

### TECHNICAL FIELD

The invention relates to the field of passenger service vehicles. In particular, but not exclusively, the invention relates to a wheelchair restraint for passenger service vehicles, as well as associated apparatus, structures, vehicles and methods.

### BACKGROUND

As used herein, the term “passenger service vehicle” encompasses vehicles for transporting passengers and, in particular, road vehicles for transporting passengers. Exemplary passenger service vehicles may be buses, coaches or the like.

Significant innovation and technology development has occurred in recent years in relation to the design of passenger service vehicles. In particular, there has been a continued drive towards providing vehicles that allow for, for example, improved passenger seating, vehicle handling, fuel efficiency, and ease of maintenance, etc.

Such improvements have included enhanced vehicle access such as to allow pushchairs, wheelchairs and the like to be transported or more readily transported in passenger service vehicles.

This background serves only to set a scene to allow a skilled reader to better appreciate the following description. Therefore, none of the above discussion should necessarily be taken as an acknowledgement that that discussion is part of the state of the art or is common general knowledge. One or more aspects/embodiments of the invention may or may not address one or more of the background issues.

### SUMMARY

According to an aspect of the invention there is provided a wheelchair restraint for a passenger service vehicle.

At least a portion of the restraint may be reconfigurable between a first position and a second position. The first position may comprise a storage or access position. The second position may comprise an operational or restraining position. The at least a portion of the restraint may comprise a restraining member.

The restraining member may comprise a substantially rigid member. The rigid member may comprise a tubular portion. The tubular portion may be box, oval, round cross-section, or the like. The restraining member may comprise one or more of: an arm; a rod; a panel; a rail; a barrier and/or the like.

The first position may comprise a storage position that provides or allows access to a wheelchair berth or parking location. The access may comprise wheeled access, such as by the wheelchair occupant or an accompanying pusher/driver of the wheelchair, such that the wheelchair may be parked and/or driven out of the wheelchair berth or parking location when the portion of the restraint is in the first position.

The restraint may be configured to be mounted and/or operable in association with an additional or alternative wheelchair restraint. The additional or alternative wheelchair restraint may comprise a wheelchair support. The wheelchair support may comprise a support to restrain the wheelchair in normal use and/or in the event of a sharp or sudden change of direction or velocity of the vehicle. For example, the wheelchair support may comprise a backrest for the wheelchair. Alternatively, the wheelchair support may comprise a front or side wheelchair support.

The first position may locate the portion of the restraint substantially outside the wheelchair berth or parking location. The first position may locate the portion of the restraint substantially outside of a passenger area or volume (e.g. not in a passenger passageway or transit location). The passenger area or volume may include the wheelchair berth. The first position may locate the portion of the restraint substantially away from the wheelchair berth or parking location. The first position may locate the portion of the restraint distal to the wheelchair berth or parking location, relative to the second position. The first position may locate the restraining member such that the restraining member is at least partially separated from the wheelchair berth or parking location by another portion of the vehicle. The another portion of the vehicle may comprise the additional or alternative wheelchair support. For example, the first position may locate the restraining member behind the backrest.

The first position may allow an alternative or additional use of the wheelchair berth or parking location. For example, the first position may allow use of the wheelchair berth or parking location by non-wheelchair users, such as when no wheelchair is present. Such use may include standing use by passengers and/or seated use by passengers, such as on reconfigurable seating (e.g. fold down seat/s).

In the first position, the restraining member may be concealed, or substantially concealed. The restraining member may be movable from the second position to the first position, so as to conceal, or substantially conceal, the restraining member member (e.g. when not in use).

When in the second position, the restraint may be configured to prevent or at least restrict movement of the wheelchair relative to the vehicle, such as in the event of a sharp or sudden change of direction or velocity of the vehicle. In normal use, the restraint may be configured not to contact the wheelchair when in the second position.

The restraint may be configured to (only) contact the wheelchair when in the second position (only) in the event of movement of the wheelchair relative to the vehicle. Alternatively, the restraint may be configured to contact the wheelchair when in the second position; such as not only in the event of a sharp or sudden change of direction or velocity of the vehicle.

In normal use, the restraint may be configured to be non-engagingly positioned adjacent the wheelchair in the second position. Alternatively, the restraint may be configured to be engagingly positioned adjacent the wheelchair so as to contact the wheelchair in normal use in the second position. Normal use may comprise transit of the vehicle other than a sharp or sudden change of direction or velocity of the vehicle. The sharp or sudden change of direction or velocity may be a result of a crash or impact and/or an evasive manoeuvre. The sharp or sudden change of direction or velocity may be a result of a frontal collision.

The restraining member may be pivotally mounted such that the restraining member pivots between the first and second positions. The restraining member may be pivotally mounted such that the restraining member pivots about a first pivot axis between the first and second positions. The restraining member may be pivotally mounted such that the restraining member pivots about a second pivot axis between the first and second positions. The first and second pivot axes may be discrete. The first and second pivot axes may be substantially perpendicular. The restraining member may be pivotable about the first pivot axis during a first stage of reconfiguration from the first position to the second position. The restraining member may be pivotable about the second pivot axis during a second stage of reconfiguration from the first position to the second position. The restraining member may be pivotable about the second pivot axis during a first stage of reconfiguration from the second position to the first position. The restraining member may be pivotable about the first pivot axis during a second stage of reconfiguration from the second position to the first position. Providing two pivot axes may allow the restraining member to be located in a first plane in the first position and a second plane in the second position. The first and second planes may be substantially perpendicular. For example, the first plane may be substantially perpendicular to the vehicle, such as perpendicular to a longitudinal axis, aisle or passageway of the vehicle; and the second plane may be substantially in line with or parallel to the longitudinal axis, aisle or passageway of the vehicle.

The first and second stages of reconfiguration from the first position to the second position may be discrete, such as consecutive, stages. Alternatively, the first and second stages of reconfiguration from the first position to the second position may at least partially overlap, such as to be at least partially concurrent.

The first and second stages of reconfiguration from the second position to the first position may be discrete, such as consecutive, stages. Alternatively, the first and second stages of reconfiguration from the second position to the first position may at least partially overlap, such as to be at least partially concurrent.

The first position may comprise a substantially upright position. The second position may comprise a substantially horizontal position. Reconfiguring the restraining member between a substantially upright position when not in use and a substantially horizontal position when in use may allow the restraining member to comprise a smaller footprint in the first position relative to a footprint in the second position. Reconfiguring the restraining member between a substantially upright position when not in use and a substantially horizontal position when in use may allow the restraining member to comprise a greater length in use than may otherwise be possible.

The restraining member may be pivotable during the first stage of reconfiguration from the first position to the second position such that the restraining member is pivoted inwards, such as towards the passageway or aisle of the vehicle, during the first stage of reconfiguration from the first position to the second position. The restraining member may be pivotable during the second stage of reconfiguration from the first position to the second position such that the restraining member is pivoted downwards, such as along the passageway or aisle of the vehicle, during the second stage of reconfiguration from the first position to the second position. The restraining member may be pivotable during the first stage of reconfiguration from the second position to the first position such that the restraining member is pivoted upwards, such as along the passageway or aisle of the vehicle, during the first stage of reconfiguration from the second position to the first position. The restraining member may be pivotable during the second stage of reconfiguration from the second position to the first position such that the restraining member is pivoted outwards, such as away from the passageway or aisle of the vehicle, during the second stage of reconfiguration from the second position to the first position.

The restraining member may be supported at a first end portion in the first and/or second position/s. The restraining member may be pivotally supported at the first end portion.

The retraining member may be substantially unsupported or free at a second end portion in the first and/or second position/s. The restraining member may form a cantilever in the first and/or second position/s. The restraining member may be non-removably mounted, such as substantially permanently attached at the first end portion.

The restraining member may be mounted so as to provide a horizontal separation between the first end portion and the second end portion when in the second position. The horizontal separation may comprise a vector with a component non-parallel to the longitudinal axis of the vehicle and/or aisle or passageway. The non-parallel component may be defined by a lateral portion of the restraint. The non-parallel component may correspond to a lateral portion of the restraining member. The vector may comprise a component with a component substantially parallel to the longitudinal axis of the vehicle and/or aisle or passageway. The substantially parallel component may be defined by a longitudinal portion of the restraint. The substantially parallel component may correspond to a longitudinal portion of the restraining member. The first end portion and/or at least one of the pivot axes may be spaced or separated from the aisle or passageway, such as by at least a portion of the non-parallel component. Spacing at least one of the pivot axes from the aisle or passageway may allow the restraint to project or encroach less or even not at all into the aisle or passageway in at least one of the positions. The axis spaced from the aisle or passageway may be substantially parallel to the aisle or passageway.

When in the second position, the restraint may comprise a component substantially parallel to the aisle or passageway and/or the vehicle longitudinal axis; and a component substantially non-parallel to the aisle or passageway and/or the vehicle longitudinal axis. The restraining member may comprise the parallel and non-parallel components. The restraining member may comprise a bend or elbow, such as intermediate the first and second end portions. The bend or elbow may be located more proximal to the first end portion than the second end portion. The elbow or a bend may assist in allowing the restraint to have a reduced footprint and/or projection into the aisle or passageway when the restraint is in the first position.

The restraint may be configured to prevent deformation or deflection of the restraining member. The restraint may be reinforced. The elbow or bend may comprise a reinforcement, such as a rib, strut, stiffening member or the like.

The restraint may be configured to limit movement of the restraining member. For example, the restraint may comprise a guide portion configured to limit or define a path or movement of the restraining member between the first and second positions. The guide may be configured to limit movement of the restraining member such as to support the restraining member in the first and/or second position/s. The restraint may be configured to prevent undesired or non-useful pivoting or rotation of the restraining member (e.g. away from the first and second positions or along the aisle in an unintended direction, such as away from the first position towards the front of vehicle when used for a rear-facing wheelchair berth). The guide may limit pivoting of the restraining member about the first and/or second pivot axis/es. The restraint may be configured to prevent pivot in unintended or undesired direction. For example, the restraint may be configured to prevent undesired collision of the restraining member with parts of the vehicle, such as windows or the floor. The restraint may be configured to limit movement of the restraining member to the first and second positions and intermediate positions exclusively therebetween. The guide may define a path with start and/or end stop/s. The guide may define a maximum angle of pivot or rotation; and/or absolute start and/or end pivot locations or angles about at least one of the pivot axes. For example, the guide may define a substantially horizontal orientation of the restraining member in the second position. The guide may define a substantially upright orientation of the restraining member in the first position. The guide may define or restrict angular rotation about the first pivot axis.

The restraint may comprise a pivot limiter configured to limit rotation of the restraining member about the first and/or second axis/es. The pivot limiter may define a maximum angle of pivot or rotation; and/or absolute start and/or end pivot locations or angles. For example, the pivot limiter may define a substantially horizontal orientation of the restraining member in the second position. The pivot limiter may define a substantially upright or over-upright orientation of the restraining member in the first position. The pivot limiter may define or restrict angular rotation about the second pivot axis.

The first and/or second position/s may comprise a locked position. For example, the restraint may be mounted such that the restraint substantially prevents unintended reconfiguration between the first and second positions. The restraint may comprise a lock. The lock may be configured to prevent reconfiguration of the restraining member between the first and second configurations. The lock may allow the restraint to be safely configured in the first and/or second position/s during transit of the vehicle in normal use and optionally in the event of a sharp or sudden change in velocity or direction of the vehicle. The lock may be a user-actuatable lock. The lock may be self-actuated, such as when the restraint is reconfigured from the second to the first position. A portion of the weight of the restraining member may assist in retaining the restraining member in the first and/or second position/s. The lock may be defined by the guide, such as a portion of the path.

The restraint may be configured to prevent unintended reconfiguration or unintended partial reconfiguration. The restraint may be configured to require upwards movement of the restraining member to initiate reconfiguration between the first and second positions. Upwards movement may be required to initiate reconfiguration from the first position to the second position and/or from the second position to the first position. The required upwards movement may be of the first and/or second end portion/s. The required movement/s may be defined by the guide and/or the pivot limiter and/or the lock.

The restraint may comprise a side restraint. When in the second position, the restraint may be configured to restrain movement of the wheelchair laterally, relative to a longitudinal axis and/or direction of travel of a vehicle. When in the second position, the restraint may be configured to restrain movement of the wheelchair laterally, relative to a front direction of the wheelchair. The restraint may comprise an aisle-side barrier.

The restraint may be configured to restrain a rearwards-facing wheelchair in the passenger service vehicle. Alternatively, the restraint may be configured to restrain a sideways or forwards-facing wheelchair.

The restraint may be configured to restrain a single wheelchair, such as a single wheelchair in the wheelchair berth adjacent the restraint. The restraint may be configured to restrain an occupied wheelchair.

The restraint may be configured to supplement and/or replace an additional wheelchair restraint/s. For example, the restraint may be configured to supplement and/or replace a strapping, anchor or other securement temporarily fixed to the wheelchair to prevent or restrict movement of the wheelchair relative to the vehicle during transit of the vehicle. The restraint may be configured to allow transit of the vehicle without anchoring the wheelchair to the vehicle. The restraint may be configured to allow a wheelchair user/occupant to enter, park and/or exit the berth substantially unaided. For example, the restraint may enable the wheelchair to be sufficiently safely restrained such that straps or anchors, such as applied by a vehicle driver or other non-wheelchair user, are not required. The restraint may allow reconfiguration between the first and second positions by the wheelchair user/occupant. The restraint may allow reconfiguration between the first and second positions by the wheelchair user/occupant when seated in the wheelchair in the wheelchair berth. At least a portion of the restraining member may be accessible to the wheelchair occupant when the wheelchair is in the berth and the restraining member is in the first position. At least a portion of the restraining member may protrude from the another portion of the vehicle. For example, at least a portion of the restraining member may protrude above and/or below and/or laterally from a projection of the backrest. The accessible portion/s of the restraining member may comprise the second end portion.

Reconfiguration of the restraint from the first position to the second position may be at least partially assisted. Reconfiguration of the restraint from the first position to the second position may be at least partially assisted by gravity. Reconfiguration of the restraint during the first and/or second stage/s of reconfiguration from the first position to the second position may be at least partially assisted.

According to a further aspect of the invention there is provided a method of restraining a wheelchair in a passenger service vehicle, the method comprising reconfiguring a restraint according to any other aspect or embodiment from a first position to a second position.

According to a further aspect of the invention there is provided a passenger service vehicle wheelchair restraint according to any other aspect or embodiment.

The passenger service vehicle may comprise a twin or double deck vehicle.

Alternatively, the passenger service vehicle may comprise a single deck vehicle or a split deck vehicle.

The vehicle may comprise a plurality of wheelchair restraints. The vehicle may comprise a plurality of wheelchair restraints per a/each wheelchair parking berth. The vehicle may comprise a plurality of wheelchair berths or parking locations. The/each berth may comprise one or more wheelchair restraints, such as the wheelchair restraint/s of any other aspect.

According to a further aspect of the invention there is provided a passenger service vehicle comprising a wheelchair restraint according to any other aspect or embodiment.

According to a further aspect of the invention there is provided a method of equipping a passenger service vehicle with a wheelchair restraint according to any other aspect or embodiment, the method comprising mounting at least a portion of the restraint so as to be reconfigurable between a first position and a second position.

According to a further aspect of the invention there is provided a wheelchair restraint for a passenger service vehicle comprising a substantially rigid restraining member reconfigurable between a first position and a second position, wherein the first position comprises a storage or access position that provides or allows wheeled access to a wheelchair berth or parking location with the restraining member stored behind the backrest, and the second position comprises an operational or restraining position.

The invention includes one or more corresponding aspects, embodiments or features in isolation or in various combinations whether or not specifically stated (including claimed) in that combination or in isolation. For example, features associated with particular recited embodiments and/or aspects relating to the body part per se, may be equally appropriate as features of embodiments relating to the passenger service vehicle, and vice versa. As will be appreciated, features associated with particular recited embodiments and/or aspects relating to methods, may be equally appropriate as features of embodiments and/or aspects relating specifically to apparatus, and vice versa.

It will also be appreciated that one or more embodiments/aspects may be useful for restraining wheelchairs in passenger service vehicles.

The above summary is intended to be merely exemplary and non-limiting.

As used herein, the term “comprise” is intended to include at least: “consist of”; “consist essentially of”; “include”; and “be”. For example, it will be appreciated that where the restraint part may “comprise a restraining member”, the restraint may “include a restraining member” (and optionally other element/s); the restraint “may be a restraining member”; or the restraint may “consist essentially (only) of a restraining member”; etc. For brevity and clarity not all of the permutations of each recitation of “comprise” have been specifically stated.

### BRIEF DESCRIPTION OF THE FIGURES

A description is now given, by way of example only, with reference to the accompanying drawings, in which:

FIGS. 1a and 1b show examples of passenger service vehicles;

FIG. 2 shows a perspective exploded view of a wheelchair restraint;

FIG. 3 shows a perspective exploded view of the wheelchair restraint of FIG. 2;

FIG. 4 shows a partial exploded view of a portion of the wheelchair restraint of FIG. 2;

FIG. 5 shows an isometric view of the restraint of FIG. 2 mounted in a passenger service vehicle and in a second or operational position, showing an unoccupied wheelchair;

FIG. 6 shows a detail view of a portion of FIG. 5;

FIG. 7 shows a further embodiment of a wheelchair restraint with the restraint in a first or storage position; and

FIG. 8 shows the wheelchair restraint of FIG. 7 in a second or operational position.

### DESCRIPTION OF SPECIFIC EMBODIMENTS

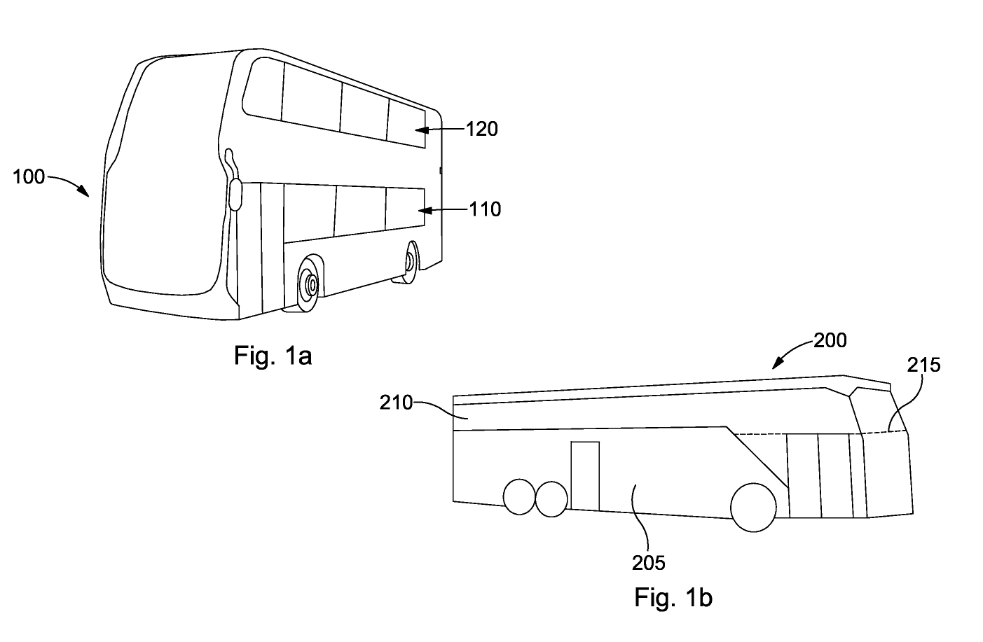

FIG. 1a shows a perspective representation of a passenger service vehicle 100, which, in this example, is shown as a vehicle 100 having both a lower passenger deck 110 (lower deck) and an upper passenger deck 120 (upper deck). Such vehicles 100 are commonly referred to as twin-deck, or double-deck, vehicles 100, and comprise a plurality of passenger seats on each deck.

FIG. 1b shows a perspective representation of an alternative passenger service vehicle 200, having essentially only a single passenger deck 210 (albeit there may be provided a few passenger seats on lower sections of the vehicle also). The vehicle 200 shown in FIG. 1b can be considered to be a coach-type vehicle, in which the passenger deck 210 may be elevated above a luggage locker area 205, or the like. In some examples of such vehicles, the passenger deck 210 may extend for substantially the length of the vehicle 200, and so above a driver area 215 (as shown by the dashed lines 215). Other single deck vehicles 200 are also known.

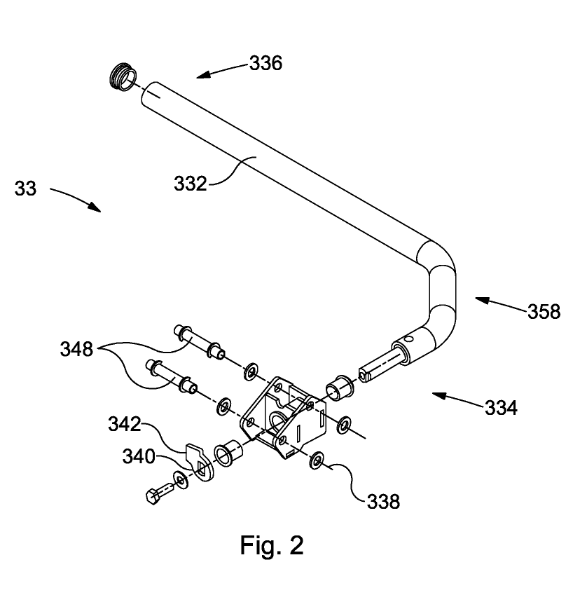

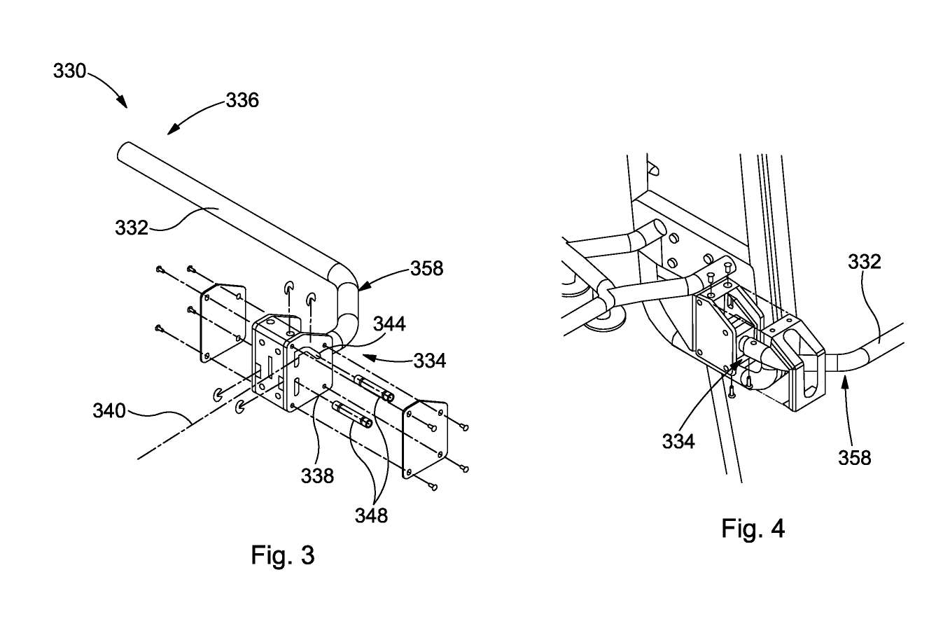

FIGS. 2, 3 and 4 show various perspective exploded views of a wheelchair 350 restraint 330 for a passenger service vehicle according to a first embodiment of the present invention. The restraint 330 comprises a restraining member 332 reconfigurable between a first position and a second position. The first position comprises a storage or access position. The second position comprises an operational or restraining position.

Here, the restraining member 332 comprises a substantially rigid member in the form of an arm formed of a tubular portion of round cross-section. The restraining member 332 is pivotally supported at a first end portion 334 in the first and second positions.

The restraining member 332 is substantially unsupported or free at a second end portion 336 in the first and second positions. The restraining member 332 forms a cantilever in the second position. The restraining member 332 is non-removably mounted, which is substantially permanently attached at the first end portion 334 once mounted here.

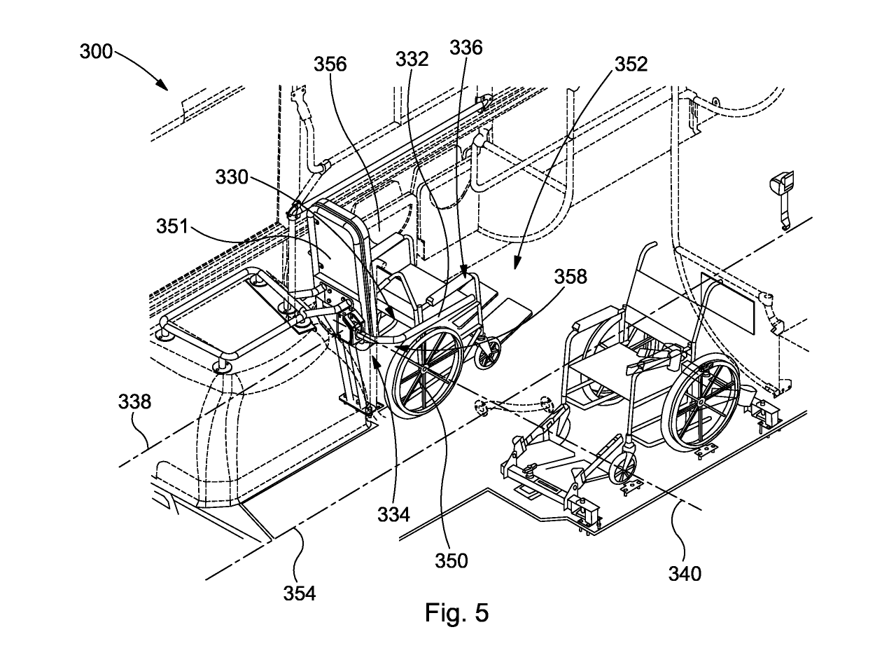

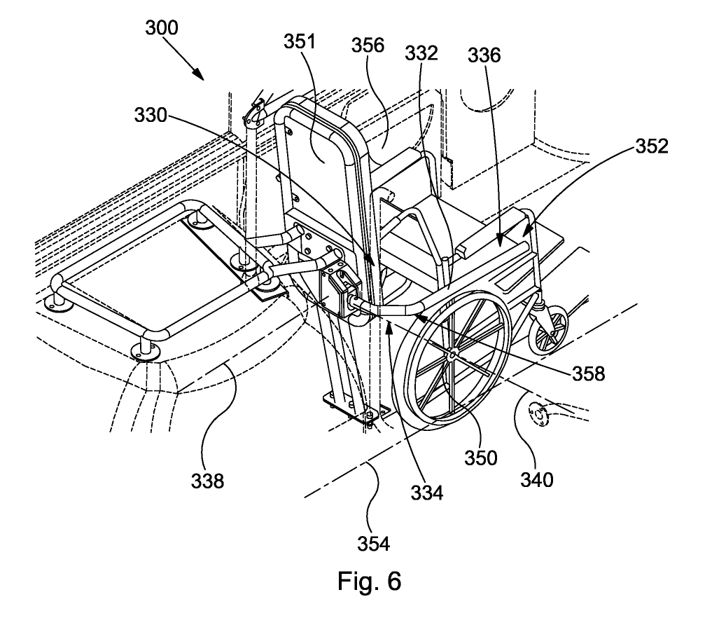

The restraining member 332 is pivotally mounted such that the restraining member 332 pivots between the first and second positions. The restraining member 332 is pivotally mounted such that the restraining member 332 pivots about a first pivot axis 338 338 between the first and second positions. The restraining member 332 is pivotally mounted such that the restraining member 332 pivots about a second pivot axis 340 340 between the first and second positions. The first and second pivot axes are discrete and substantially perpendicular in the embodiment shown. The restraining member 332 is pivotable about the first pivot axis 338 during a first stage of reconfiguration from the first position to the second position. The restraining member 332 is pivotable about the second pivot axis 340 during a second stage of reconfiguration from the first position to the second position. The restraining member 332 is pivotable about the second pivot axis 340 during a first stage of reconfiguration from the second position to the first position. The restraining member 332 is pivotable about the first pivot axis 338 during a second stage of reconfiguration from the second position to the first position. Providing two pivot axes allows the restraining member 332 to be located in a first plane in the first position and a second plane in the second position. The first and second planes are substantially perpendicular. For example, as shown in FIGS. 5 and 6, the first plane is substantially perpendicular to the vehicle 300, such as perpendicular to a longitudinal axis, aisle 354 or passageway of the vehicle 300; and the second plane is substantially in line with or parallel to the longitudinal axis, aisle 354 or passageway of the vehicle 300.

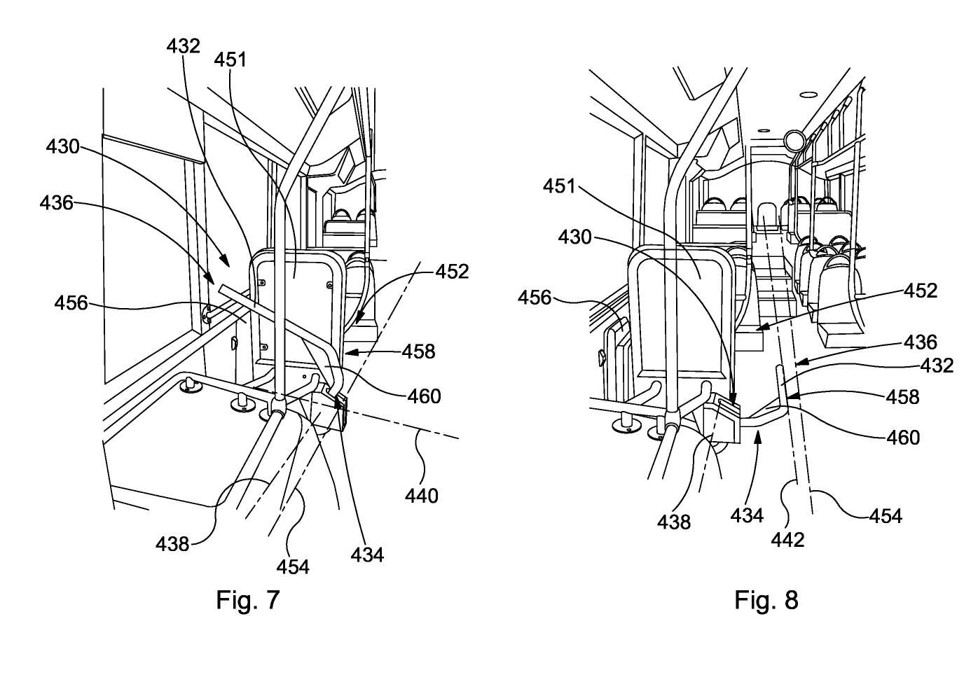

The restraint 330 comprises a pivot limiter 342 configured to limit rotation of the restraining member 332 about the second pivot axis 340. The pivot limiter 342 defines a maximum angle of pivot or rotation; and absolute start and end pivot locations or angles. Here, the pivot limiter 342 defines a substantially horizontal orientation of the restraining member 332 in the second position (as shown in FIGS. 5 and 6). The pivot limiter 342 defines a substantially upright or over-upright orientation of the restraining member 332 in the first position (similar to that of the embodiment in FIG. 7). The pivot limiter 342 defines or restricts angular rotation about the second pivot axis 340.

The restraint 330 is configured to limit movement of the restraining member 332. Here, the restraint 330 comprises a guide 344 portion configured to limit or define a path or movement of the restraining member 332 between the first and second positions, using a slot 346 and pin 348 arrangement in the embodiment shown. The guide 344 is configured to limit movement of the restraining member 332 such as to support the restraining member 332 in the first and second positions. The restraint 330 is configured to prevent undesired or non-useful pivoting or rotation of the restraining member 332 (e.g. away from the first and second positions or along the aisle 354 in an unintended direction, such as away from the first position towards the front of vehicle when used for a rear-facing wheelchair 350 berth 352). The guide 344 limits pivoting of the restraining member 332 about the first pivot axis 338 and is configured to prevent pivot in unintended or undesired directions.

The restraint 330 is configured to prevent undesired collision of the restraining member 332 with parts of the vehicle, such as windows or the floor. The restraint 330 is configured to limit movement of the restraining member 332 to the first and second positions and intermediate positions exclusively therebetween. The guide 344 defines the path with start and end stops. The guide 344 defines a maximum angle of pivot or rotation; and absolute start and end pivot locations or angles about the first pivot axis 338. Here, the guide 344 defines a substantially horizontal orientation of the restraining member 332 in the second position and a substantially upright orientation of the restraining member 332 in the first position.

Here, the first position comprises a locked position. The restraint 330 is mounted such that the restraint 330 substantially prevents unintended reconfiguration between the first and second positions. The restraint 330 comprises a lock in the form of a portion of the path defined by the guide 344. The lock is configured to prevent reconfiguration of the restraining member 332 between the first and second positions. The lock allows the restraint 330 to be safely configured in the first position during transit of the vehicle in normal use and optionally in the event of a sharp or sudden change in velocity or direction of the vehicle. The lock is self-actuated, such as when the restraint 330 is reconfigured from the second to the first position by a user. The path defined by the guide 344 comprises substantially vertical components towards start and end stops defining the first and second positions of the restraining member 332 about the first pivot axis 338. Accordingly, the restraint 330 is configured to prevent unintended reconfiguration or unintended partial reconfiguration by requiring upwards movement of the restraining member 332 to initiate reconfiguration between the first and second positions. Upwards movement is required to initiate reconfiguration from the first position to the second position and from the second position to the first position. The required upwards movement is of the first and second end portion 336s for initiations of both reconfiguration between positions. The required movement is defined by the guide 344 and the pivot limiter 342.

Due to the form of the path and the lock defined by the guide 344, a portion of the weight of the restraining member 332 assists in retaining the restraining member 332 in the first and second positions. Reconfiguration of the restraint 330 during the first and second stages of reconfiguration from the first position to the second position is at least partially assisted by gravity.

Here, the first and second stages of reconfiguration from the first position to the second position are discrete, such as consecutive, stages. Similarly, the first and second stages of reconfiguration from the second position to the first position are discrete, such as consecutive, stages.

Reference is now made to FIGS. 5 and 6, which show isometric views of the restraint 330 of FIG. 2 mounted in a passenger service vehicle and in a second or operational position, showing an unoccupied wheelchair 350.

Although not shown in the figures, it will be appreciated that the first position comprises a substantially upright position. As shown in FIGS. 5 and 6, the second position comprises a substantially horizontal position. Reconfiguring the restraining member 332 between a substantially upright position when not in use and a substantially horizontal position when in use allows the restraining member 332 to comprise a smaller footprint in the first position relative to a footprint in the second position. Reconfiguring the restraining member 332 between a substantially upright position when not in use and a substantially horizontal position when in use allows the restraining member 332 to comprise a greater length in use than may otherwise be possible.

As can be seen in FIGS. 5 and 6, here the restraint 330 comprises a side restraint 330. When in the second position of FIGS. 5 and 6, the restraint 330 is configured to restrain movement of the wheelchair 350 laterally, relative to a longitudinal axis and direction of travel of the vehicle. When in the second position, the restraint 330 is configured to restrain movement of the wheelchair 350 laterally, relative to a front direction of the wheelchair 350. The restraint 330 comprises an aisle 354-side barrier.

The restraint 330 is configured to restrain a rearwards-facing wheelchair 350 in the passenger service vehicle. The restraint 330 is configured to restrain a single wheelchair 350 in the wheelchair 350 berth 352 adjacent the restraint 330. Although shown unoccupied, it will be appreciated that the restraint 330 is configured to restrain an occupied wheelchair 350. The restraint 330 is configured to be mounted and operable in association with a wheelchair 350 support in the form of a backrest 351 here. The wheelchair 350 support comprises a support to restrain the wheelchair 350 in normal use and in the event of a sharp or sudden change of direction or velocity of the vehicle.

The restraint 330 is configured to allow replacement of additional or alternative wheelchair 350 anchors or fixings, such as strapping temporarily fixed to the wheelchair 350 (such as applied by a vehicle driver or other non-wheelchair 350 user) to prevent or restrict movement of the wheelchair 350 relative to the vehicle during transit of the vehicle. The restraint 330 is configured to allow transit of the vehicle without anchoring the wheelchair 350 to the vehicle. It will be appreciated that the wheelchair 350 may comprise a brake to limit movement and the backrest 351 and restraint 330 are intended to restrain movement in the event of a sudden change of direction or velocity. The restraint 330 is configured to allow a wheelchair 350 user/occupant to enter, park and exit the berth 352 substantially unaided. The restraint 330 allows reconfiguration between the first and second positions by the wheelchair 350 user/occupant when seated in the wheelchair 350 in the wheelchair 350 berth 352. At least a portion of the restraining member 332 is accessible to the wheelchair 350 occupant when the wheelchair 350 is in the berth 352 and the restraining member 332 is in the first position. Here, at least a portion of the restraining member 332 protrudes above and laterally from a projection of the backrest 351.

It will be appreciated that the first position (similar to that of the embodiment shown in FIG. 7) comprises a storage position that provides or allows wheeled access to the wheelchair 350 berth 352 or parking location by the wheelchair 350 occupant or an accompanying pusher/driver of the wheelchair 350, such that the wheelchair 350 is parked and driven out of the wheelchair 350 berth 352 or parking location when the restraining member 332 is in the first position.

The first position locates the restraining member 332 substantially outside of a passenger area or volume (e.g. not in a passenger passageway or transit location), including the wheelchair 350 berth 352. The first position locates the restraining member 332 substantially away from the wheelchair 350 berth 352 or parking location. The first position locates the portion of the restraint 330 distal to the wheelchair 350 berth 352 or parking location, relative to the second position. The first position locates the restraining member 332 such that the restraining member 332 is at least partially separated from the wheelchair 350 berth 352 or parking location by locating the restraining member 332 behind the backrest 351.

The first position allows an alternative or additional use of the wheelchair 350 berth 352 or parking location. For example, the first position allows use of the wheelchair 350 berth 352 or parking location by non-wheelchair 350 users, such as when no wheelchair 350 is present. Such use may include standing use by passengers and seated use by passengers, such as on reconfigurable seating (e.g. fold down seats 356).

When in the second position, the restraint 330 is configured to prevent or at least restrict movement of the wheelchair 350 relative to the vehicle, such as in the event of a sharp or sudden change of direction or velocity of the vehicle. In normal use, the restraint 330 is configured not to contact the wheelchair 350 when in the second position. The restraint 330 is configured to only contact the wheelchair 350 when in the second position only in the event of movement of the wheelchair 350 relative to the vehicle. In normal use, the restraint 330 is configured to be non-engagingly positioned adjacent the wheelchair 350 in the second position. Normal use comprises transit of the vehicle other than a sharp or sudden change of direction or velocity of the vehicle. The sharp or sudden change of direction or velocity may be a result of a crash or impact and an evasive manoeuvre. The sharp or sudden change of direction or velocity may be a result of a frontal collision.

The restraining member 332 is pivotable during the first stage of reconfiguration from the first position to the second position such that the restraining member 332 is pivoted inwards, such as towards the passageway or aisle 354 of the vehicle, during the first stage of reconfiguration from the first position to the second position. The restraining member 332 is pivotable during the second stage of reconfiguration from the first position to the second position such that the restraining member 332 is pivoted downwards, such as along the passageway or aisle 354 of the vehicle, during the second stage of reconfiguration from the first position to the second position. The restraining member 332 is pivotable during the first stage of reconfiguration from the second position to the first position such that the restraining member 332 is pivoted upwards, such as along the passageway or aisle 354 of the vehicle, during the first stage of reconfiguration from the second position to the first position. The restraining member 332 is pivotable during the second stage of reconfiguration from the second position to the first position such that the restraining member 332 is pivoted outwards, such as away from the passageway or aisle 354 of the vehicle, during the second stage of reconfiguration from the second position to the first position.

The restraining member 332 is mounted so as to provide a horizontal separation between the first end portion 334 and the second end portion 336 when in the second position. The horizontal separation comprises a vector with a component non-parallel to the longitudinal axis of the vehicle and aisle 354 or passageway. The non-parallel component corresponds to a lateral portion of the restraining member 332. The vector comprises a component with a component substantially parallel to the longitudinal axis of the vehicle and aisle 354 or passageway. The substantially parallel component corresponds to a longitudinal portion of the restraining member 332. The first end portion 334 and the first pivot pivot axis is spaced or separated from the aisle 354 or passageway, such as by at least a portion of the non-parallel component, in both the first and second positions. Such spacing allows the restraint 330 to project or encroach less or even not at all into the aisle 354 or passageway in the second position.

When in the second position, the restraint 330 comprises a component substantially parallel to the aisle 354 or passageway and the vehicle longitudinal axis; and a component substantially non-parallel to the aisle 354 or passageway and the vehicle longitudinal axis. The restraining member 332 comprises the parallel and non-parallel components. The restraining member 332 comprises a bend or elbow 358, intermediate the first and second end portion 336s. The bend or elbow 358 is located more proximal to the first end portion 334 than the second end portion 336. The elbow 358 or a bend assists in allowing the restraint 330 to have a reduced footprint and projection into the aisle 354 or passageway when the restraint 330 is in the first position.

Reference is now made to FIGS. 7 and 8, which show a wheelchair restraint 430 for a passenger service vehicle according to a second embodiment of the present invention. The restraint 430 of FIGS. 7 and 8 is generally similar to that 330 shown in FIGS. 2, 3, 4, 5 and 6, with like features referenced by like numerals incremented by 100. Accordingly, the restraint 430 comprises a restraining member 432 with a bend or elbow 458.

FIG. 7 shows the wheelchair restraint 430 with the restraint 430 in a first or storage position.

As can be seen in FIG. 7, in the first position, the restraining member 432 is concealed, or substantially concealed. The restraining member 432 is movable from the second position to the first position, so as to conceal, or substantially conceal, the restraining member 432 (e.g. when not in use) behind the backrest 451.

FIG. 8 shows the wheelchair restraint 430 of FIG. 7 in a second or operational position, generally similar to that of FIGS. 5 and 6.

The restraint 430 is configured to prevent deformation or deflection of the restraining member 432. The restraint 430 is reinforced. The elbow 458 or bend comprises a reinforcement 460, which is a rib in the embodiment shown.

It will be apparent to those of skill in the art that the above described embodiments are merely exemplary of the present invention, and that various modifications and improvements may be made thereto, without departing from the scope of the invention. For example, although shown here with a manual wheelchair, it will be appreciated that the restraint may be suitable for other mobility aids, such as powered wheelchairs or mobility scooters.

It will be appreciated that any of the aforementioned restraints may have other functions in addition to the mentioned functions, and that these functions may be performed by the same restraint.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A wheelchair restraint for a passenger service vehicle, wherein at least a portion of the restraint is reconfigurable between a first position and a second position, the first position comprising a storage or access position and the second position comprising an operational or restraining position; and the at least a portion of the restraint comprises a substantially rigid restraining member.

2. The wheelchair restraint of claim 1, wherein the restraining member comprises a tubular portion.

3. The wheelchair restraint of claim 1, wherein the restraining member comprises an arm.

4. The wheelchair restraint of claim 1, wherein the first position comprises a storage position that provides or allows wheeled access by the wheelchair occupant, such that the wheelchair is parked and driven out of a wheelchair berth associated with the wheelchair restraint when the portion of the restraint is in the first position.

5. The wheelchair restraint of claim 1, wherein the restraint is configured to be mounted and/or operable in association with an additional or alternative wheelchair support in the form of a backrest for the wheelchair; and the first position locates the restraining member behind the backrest.

6. The wheelchair restraint of claim 1, wherein the first position allows an alternative or additional use of the wheelchair berth by non-wheelchair users when no wheelchair is present, including seated use by passengers on reconfigurable seating.

7. The wheelchair restraint of claim 1, wherein, in normal use, the restraint is configured to be non-engagingly positioned adjacent the wheelchair in the second position.

8. The wheelchair restraint of claim 1, wherein the first position comprises a substantially upright position and the second position comprises a substantially horizontal position.

9. The wheelchair restraint of claim 1, wherein the restraining member is pivotally mounted such that the restraining member pivots about a first pivot axis between the first and second positions.

10. The wheelchair restraint of claim 9, wherein the restraining member is pivotally mounted such that the restraining member pivots about a second pivot axis between the first and second positions.

11. The wheelchair restraint of claim 10, wherein the first and second pivot axes are substantially perpendicular.

12. The wheelchair restraint of claim 10, wherein the restraining member is pivotable about the first pivot axis during a first stage of reconfiguration from the first position to the second position; and the restraining member is pivotable about the second pivot axis during a second stage of reconfiguration from the first position to the second position.

13. The wheelchair restraint of claim 12, wherein the restraining member is pivotable during the first stage of reconfiguration from the first position to the second position such that the restraining member is pivoted inwards towards a passageway or aisle of the vehicle, during the first stage of reconfiguration from the first position to the second position.

14. The wheelchair restraint of claim 12, wherein the restraining member is pivotable during the second stage of reconfiguration from the first position to the second position such that the restraining member is pivoted downwards during the second stage of reconfiguration from the first position to the second position.

15. The wheelchair restraint of claim 14, wherein the restraining member is pivotable downwards during the second stage of reconfiguration from the first position to the second position along the passageway or aisle of the vehicle.

16. The wheelchair restraint of claim 9, wherein the restraining member is pivotally supported at a first end portion in the first and/or second position/s; and the retraining member is substantially unsupported or free at a second end portion in the first and/or second position/s.

17. The wheelchair restraint of claim 16, wherein the restraining member is mounted so as to provide a horizontal separation between the first end portion and the second end portion when in the second position, the horizontal separation comprising a vector with a component non-parallel to a longitudinal axis of the vehicle and the non-parallel component being defined by a lateral portion of the restraint; and the vector comprising a component substantially parallel to the longitudinal axis of the vehicle and the substantially parallel component is defined by a longitudinal portion of the restraining member.

18. The wheelchair restraint of claim 17, wherein the first end portion and the first pivot axis are spaced from the aisle or passageway by at least a portion of the non-parallel component to allow the restraint to project less into the aisle or passageway in the second position when compared to the first position.

19. The wheelchair restraint of claim 18, wherein, when in the second position, the restraining member comprises a component substantially parallel to the aisle or passageway and the vehicle longitudinal axis; and a component substantially non-parallel to the aisle or passageway and the vehicle longitudinal axis, wherein the restraining member comprises a bend intermediate the first and second end portions.

20. The wheelchair restraint of claim 9, wherein the restraint comprises a pivot limiter configured to limit rotation of the restraining member about the first and/or second axis/es.

21. The wheelchair restraint of claim 1, wherein the restraint comprises a guide portion configured to limit or define a path or movement of the restraining member between the first and second positions to limit movement of the restraining member to the first and second positions and intermediate positions exclusively therebetween.

22. The wheelchair restraint of claim 1, wherein the restraint comprises a side restraint, such that when in the second position, the restraint is configured to restrain movement of the wheelchair laterally, relative to a longitudinal axis of the vehicle.

23. The wheelchair restraint of claim 1, wherein the restraint is configured to restrain a rearwards-facing wheelchair in the passenger service vehicle.

24. The wheelchair restraint of claim 1, wherein the restraint is configured to allow transit of the vehicle without anchoring the wheelchair to the vehicle.

25-27. (canceled)
